(19) United States
(12) Patent Application Publication
(10) Pub. No.: US 2012/0127734 A1
(43) Pub. Date: May 24, 2012

(54) LIGHT-BULB-SHAPED LAMP

(76) Inventors: Noriyasu Tanimoto, Osaka (JP); Nobuyuki Matsui, Osaka (JP)

(21) Appl. No.: 13/387,340

(22) PCT Filed: Sep. 13, 2010
(86) PCT No.: PCT/JP2010/005579

§ 371 Date: Jan. 26, 2012

(30) Foreign Application Priority Data
Sep. 14, 2009 (JP) 2009-212088

(51) Int. Cl. F21S 2/00

(52) U.S. Cl. 362/363

(57) ABSTRACT

A bulb-type lamp has a bsae 4 to be inserted into a socket by being rotated about a central axis X of the base, a first body 6 attached to the base 4 to be freely rotatable about the central axis X; a second body 8 attached to the first body 4 to be swingable about a swing axis Y1 that intersects the central axis X; a light-emitting module 10 mounted on the second body 8; and a lighting circuit unit 12 configured to light the light-emitting module 10. The lighting circuit unit 12 is housed in the first body 6.

### TECHNICAL FIELD

The present invention relates to bulb-type lamps, and in particular to bulb-type lamps having a relatively directive light-emitting element, such as a light-emitting diode (LED).

### BACKGROUND ART

The use of bulb-type (compact) fluorescent lamps is increasing, as these lamps have a longer life and are more efficient than incandescent light bulbs, while being usable directly in sockets for incandescent light bulbs. Bulb-type LED lamps, which are easily made compact and have a life and efficiency superior even to bulb-type fluorescent lamps, have also become available. To permit replacement of incandescent light bulbs, such bulb-type lamps are provided with the same sort of base as incandescent light bulbs. Furthermore, to be usable when directory attached to an existing lighting fixture for incandescent light bulbs, such bulb-type lamps have a lighting circuit provided therein.

Bulb-type fluorescent lamps have been commercialized as a replacement for incandescent light bulbs, specifically for silica bulbs having an E26 base.

There is also a desire for a replacement light source to be developed for small light bulbs, of which mini krypton bulbs are representative. Mini krypton bulbs having an E17 base are smaller incandescent light bulbs than silica bulbs having an E26 base. However, it is difficult to reduce the size of a fluorescent bulb to a desired level. Therefore, development of replacement light sources using LEDs is under study.

Existing lighting fixtures that use mini krypton bulbs are typically downlights. In at least 90% of these downlights, the bulb is attached horizontally (i.e. so that the axis of the base is orthogonal to the vertical axis) or at a nearly horizontal inclination.

By contrast, typical bulb-type LED lamps (Patent Literature 1) are provided with an LED module that is a light-emitting module for shining light primarily in a forward direction along the axis of the base. Therefore, bulb-type LED lamps are not appropriate for the above downlight fixtures.

In view of the above, there is suggested a bulb-type LED lamp enabled to direct light from an LED module toward a surface to be illuminated in accordance with the angle at which the bulb-type LED lamp is attached (Patent Literature 2).

A bulb-type LED lamp according to Patent Literature 2 has a spherical body (casing) held by a first shaft and a second shaft. The first shaft passes through the center of the spherical body, and the second shaft is coupled to the first shaft at the center of the spherical body to define a T-shape. That is, the second shaft extends radially of the spherical body. The spherical body is supported on the first shaft to be freely rotatable relative to the first shaft. The spherical body has a radial slit that is recessed in the surface to be longitudinally perpendicular to the first shaft, and the second shaft extends through the slit beyond the spherical body. In addition, the second shaft is fixed at one end to a cover attached to a base having a substantially cylindrical shape in a manner that the second shaft coincides with the vertical axis of the base.

An LED module is provided inside the spherical body at a position on an imaginary extension of the second shaft in a direction opposite the base.

In addition, most of the lighting circuit for lighting the LED module is housed in the cavity inside the base.

According to Patent Literature 2, after being attached to a lighting fixture by inserting the base into the socket, the bulb-type LED lamp having the above structure is rotated about the second shaft to such a position that the first shaft is horizontally oriented. The LED lamp is then rotated about the first shaft to such a position that the LED module faces downward.

### CITATION LIST

### [Patent Literature]

### [Patent Literature 1]

JP patent application publication No. 2009-037995

### [Patent Literature 2]

JP patent application publication No. 2008-251444

### SUMMARY OF INVENTION

### [Technical Problem]

Unfortunately, however, the bulb-type LED lamp according to Patent Literature 2 involves the following setback. That is, although a large portion of the lighting circuit is described as being housed in the base, it is practically difficult to house the in a small base, such as an E17 base having a limited interior space.

That is, the bulb-type LED lamp according to Patent Literature 2 may be usable as a replacement light source for a silica bulb, which is relatively large in size and has an E26 base. Yet, it may be difficult to modify the LED bulb-type lamp according to Patent Literature 2 to be usable as a replacement light source for a mini krypton bulb, which is relatively small in size and has an E17 base.

In view of the problems noted above, the present invention aims to provide a bulb-type lamp that is usable as a replacement light source for a small incandescent light bulb.

### [Solution to Problem]

In order to achieve the above aim, a bulb-type lamp according to the present invention includes: a base to be inserted into a socket by being rotated about a central axis of the base; a first body attached to the base to be freely rotatable about the central axis; a second body attached to the first body to be swingable about a swing axis that intersects the central axis; a light-emitting module mounted on the second body; and a lighting circuit unit configured to light the light-emitting module.

The lighting circuit unit is housed in the first body.

### ADVANTAGEOUS EFFECTS OF INVENTION

According to the bulb-type lamp having the above structure, in the state where the base is attached to the socket, the first body can be rotated relative to the base and the second body can be swung to match the direction of the surface to be illuminated. This allows the second body to be inclined to such a position that light from the light-emitting module is directed toward the surface to be illuminated. In other words, regardless of the angle at which the bulb-type lamp is attached, light from the light-emitting module can be duly directed toward the surface to be illuminated.

In addition, the first body for housing the lighting circuit unit is provided, so that the lighting circuit unit is dully housed without being required to be confined in a small space such as the cavity inside the base. This structure allows a base for a small incandescent light bulb to be used to constitute a bulb-type lamp that is usable as a replacement for a small incandescent light bulb.

### BRIEF DESCRIPTION OF DRAWINGS

FIG. 1A schematically shows a structure of a bulb-type LED lamp according to Embodiment 1, and FIG. 1B is an end view taken along the line A-A shown in FIG. 1A.

FIG. 2A is a front view, FIG. 2B is a plan view, FIG. 2C is a bottom view, and FIG. 2D is a right side view, all being views of a second body with a globe attached thereto.

FIG. 3A is a sectional view taken along the line B-B shown in FIG. 2D, and

FIG. 3B is a sectional view taken along the line C-C shown in FIG. 2A.

FIG. 4 is an exploded view showing a base and part of a first body.

FIG. 5A is a front view, FIG. 5B is a plan view, FIG. 5C is a bottom view, and FIG. 5D is a right side view, all being views of a first half-cylinder member.

FIG. 6A is a front view, FIG. 6B is a plan view, FIG. 6C is a bottom view, and FIG. 6D is a right side view, all being views of a second half-cylinder member.

FIG. 7A is a front view of a first half-shell member, FIG. 7B is a bottom view of the first body, FIG. 7C is a right side view of the first body, and FIG. 7D is an end view of the first body taken along the line G-G shown in FIG. 7A.

FIG. 8 is an oblique view of the second body with the first half-shell member and the globe attached thereto.

FIGS. 9A shows a structure of a bulb-type LED lamp according to Modification 1 of Embodiment 1, and FIG. 9B shows a structure of a bulb-type LED lamp according to Modification 2 of Embodiment 1.

FIG. 10A is a front view of a second body of a bulb-type LED lamp according to Embodiment 2 illustrated to show a mating portion, FIG. 10B is a plan view, FIG. 10C is a sectional view taken along the line M-M shown in FIG. 10A, FIG. 10D is a sectional view taken to show where a supporting portion of a first half-shell member and a supporting portion of a second half-shell member confront each other, and FIG. 10E is a sectional view taken along the line N-N shown in FIG. 10D.

FIGS. 11A and 11B each show the mating portion fitted between the supporting portions according to Embodiment 2.

### DESCRIPTION OF EMBODIMENTS

Using an example of a bulb-type LED lamp, the following describes embodiments of a bulb-type lamp according to the present invention with reference to the drawings.

### Embodiment 1

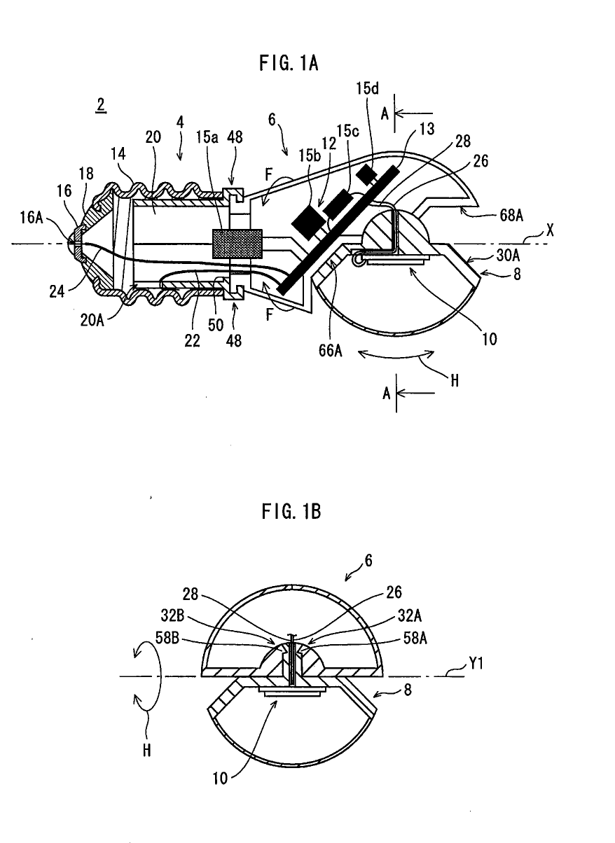

FIG. 1A schematically shows a structure of a bulb-type LED lamp 2 according to Embodiment 1, and FIG. 1B is an end view taken along the line A-A shown in FIG. 1A. Note that FIG. 1B shows the sectioned surface only. In FIG. 1A, components are shown in cross section, except for a first body 6, an LED module 10 and a lighting circuit unit 12, which will be described later.

A bulb-type LED lamp 2 has a base 4, the first body 6, and a second body 8 that are connected in the stated order. The LED module 10, which is an example of a light-emitting module, is attached to the second body 8. A large portion of the lighting circuit unit 12 for lighting the LED module 10 is housed in the first body 6.

The base 4 complies with Japanese Industrial Standards (JIS), for example with standards for an E17 base, and is used in sockets for general incandescent light bulbs (not shown in the figures). Note that the base 4 is not limited to such, but may be of a different size, such as the size specified by the standards for an E26 base.

The base 4 includes a shell 14, which is also referred to as a cylindrical portion, and an eyelet 16 shaped like a circular dish. The shell 14 and the eyelet 16 are integrated via a first insulating member 18 made of glass thereby to form an integral base body 19. This integral base body 19 is fitted into a second insulating member 20 that generally has a cylindrical shape.

The second insulating member 20 has a slit 20A. A first feeder line 22 for feeding electric power to the lighting circuit unit 12 is drawn through the slit 20A and out of the second insulating member 20.

A lead section provided at one end of the first feeder line 22 is sandwiched between the inner surface of the shell 14 and the outer surface of the second insulating member 20. The first feeder line 22 and the shell 14 are thereby electrically connected.

The eyelet 16 has a through-hole 16A provided in a central region thereof. A second feeder line 24 for feeding electric power to the lighting circuit unit 12 is drawn through the through-hole 16A, and a lead section of the second feeder line 24 is soldered to the outer surface of the eyelet 16.

The lighting circuit unit 12 converts 100 volts commercial alternating current supplied via the base 4 to direct current of a predetermined voltage and supplies the direct current to the LED module 10. The lighting circuit unit 12 includes a printed circuit board 13 and a plurality of electronic components 15a, 15b, 15c, and 15d mounted on the printed circuit board 13, and the printed circuit board 13 is attached inside the first body 6. In the example shown in the figure, part of the electronic component 15a, among the plurality of electronic components, protrudes into the interior space of the base 4 that is in communication with the first body 6. With this arrangement, in addition to the interior space of the first body 6, the interior space of the base 4 is effectively used for housing the lighting circuit unit 12. Note that it is not necessary that part of the electronic component 15a be located inside the base 4. Alternatively, the leads of the electronic component 15a may be appropriately arranged so that the electronic component 15a is entirely housed in the first body 6. In that case, the entirety of the lighting circuit unit 12 is located within the confines of the first body 6. On the other hand, depending on the circuit arrangement, it is also possible that part of two or more electronic components is located inside the base 4.

The lighting circuit unit 12 and the LED module 10 are electrically connected by a first lead wire 26 and a second lead wire 28.

The LED module 10 is mounted on the second body 8.

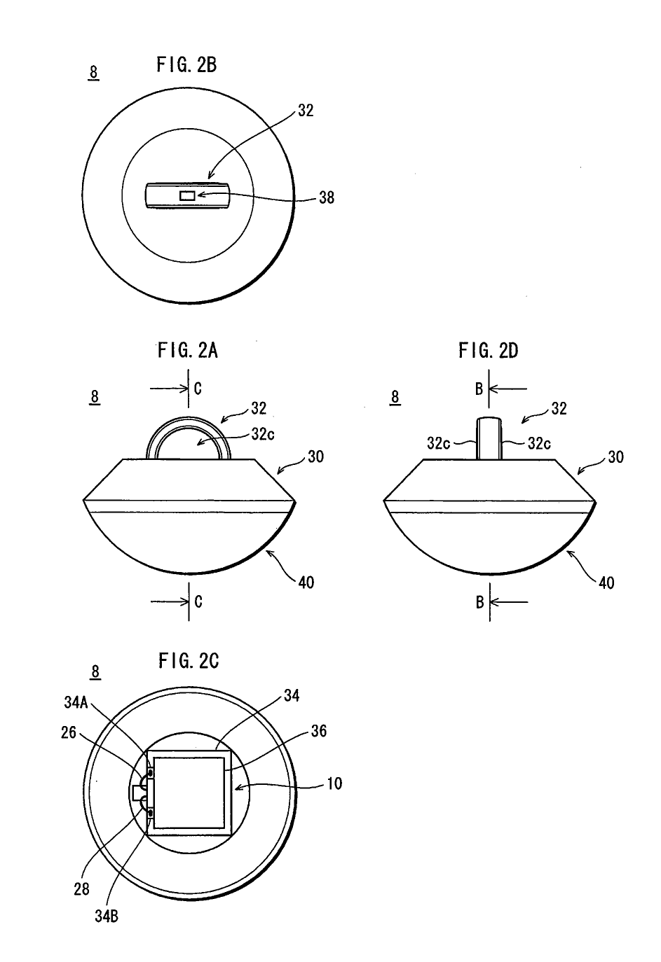

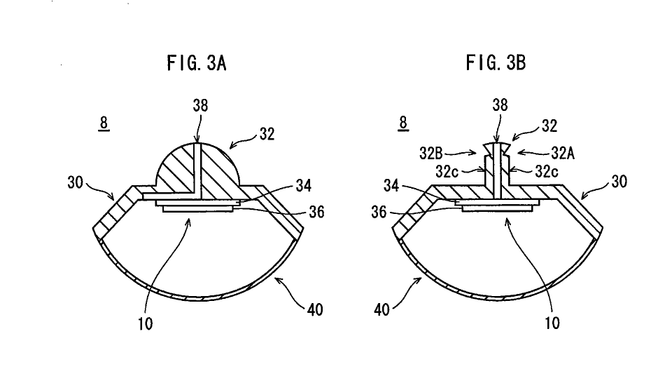

FIG. 2A is a front view, FIG. 2B is a plan view, FIG. 2C is a bottom view, and FIG. 2D is a right side view, all being views of the second body 8 to which a globe 40 is attached. In addition, FIG. 3A is a sectional view taken along the line B-B shown in FIG. 2D, and FIG. 3B is a sectional view taken along the line C-C shown in FIG. 2A. Note that these figures show the state where the LED module 10 is mounted.

The second body 8 has a main portion 30 and a mating portion 32. The main portion 30 is composed of a flat bottom and a tapered wall together defining a cup-like shape, whereas the mating portion 32 is in the form of a semi-circular plate extending from the outer bottom of the main portion 32.

The LED module 10 is mounted on the inner bottom of the main portion 30.

The LED module 10 has a rectangular printed circuit board 34. A plurality of LED chips (not shown in the figures), which are light-emitting elements, are mounted on the printed circuit board 34. These LED chips are connected in series by the wiring pattern (not shown in the figures) of the printed circuit board 34. Among the LED chips connected in series, the LED chip at the high-potential end is electrically connected at the anode (not shown in the figures) to a power supply land 34A, and the LED chip at the low-potential end is electrically connected at the cathode (not shown in the figures) to a power supply land 34B. The LED chips emit light by receiving power from the power supply lands 34A and 34B. Each LED chip may, for example, emit blue light having a peak wavelength within a region from 420 nm to 480 nm or ultraviolet light having a peak wavelength within a region from 340 nm to 420 nm. Alternatively, only one LED chip may be used in the LED module 10. When multiple LED chips are used, in addition, the LED chips are not necessarily connected in series as described above. Series-parallel connection is also possible. That is, LED arrays each composed of a predetermined number of serially connected LEDs may be connected in parallel. Providing two power supply lands in the LED module 10 along one side edge of the printed circuit board 34 as described above is not the only option. Alternatively, one power supply land may be provided at each of the two side edges. In addition, the number of the power supply lands to be provided is not limited two and three or more power supply lands may be provided. As described above, the various arrangements of the power supply lands of the LED module 10 allow the first lead wire 26 and the second lead wire 28 extending from the lighting circuit unit 12 to be freely routed. In addition, the location and shape of a hole 38 through which the first lead wire 26 and the second lead wire 28 pass can be designed more flexibly.

A translucent phosphor film 36 is coated on the LED chips mounted. The phosphor film 36 is formed by distributing yellow-green phosphor particles and red phosphor particles in a translucent resin such as silicone. Examples of yellow-green phosphor particles include (Ba,Sr)₂SiO₄:Eu²⁺ and Y₃(Al,Ga)₅O₁₂:Ce³⁺. Examples of red phosphor particles include Sr₂Si₅N₈:Eu²⁺, (Ca,Sr)S:Eu²⁺, and (Ca,Sr)AlSiN₃:Eu²⁺. In addition to the phosphor materials listed above, the following may also be used. As a yellow phosphor, Y₃Al₅O₁₂:Ce³⁺(YAG:Ce); Y₃Al₅O₁₂:Tb³⁺, i.e. terbium (Tb)-activated YAG; Y₃Al₅O₁₂:Ce³⁺,Pr³⁺, i.e. cerium (Ce) and praseodymium (Pr)-activated YAG; a thiogallate phosphor CaGa₂S₄:Eu²⁺; or an α-sialon phosphor Ca-α-SiAlON:Eu²⁺ (0.75(Ca_{0.9}Eu_{0.1})O-2.25 AlN·3.25 Si₃N₄:Eu²⁺, Ca_{1.5}Al₃Si₉N₁₆:Eu²⁺, etc.) may be used. As a green phosphor, an aluminate phosphor BaMgAl₁₀O₁₇:Eu²⁺, Mn²⁺, (Ba,Sr,Ca)Al₂O₄:Eu²⁺; an α-sialon phosphor Sr_{1.5}Al₃Si₉N₁₆:Eu²⁺; Ca-α-SiAION:Yb²⁺; a β-sailon phosphor β-Si₃N₄:Eu²⁺; oxonitridosilicate (Ba,Sr,Ca)Si₂O₂N₂:Eu²⁺, oxonitridoaluminosilicate (Ba,Sr,Ca)₂Si₄AlON₇:Ce³⁺, or (Ba,Sr,Ca)Al₂₋ₓSiₓO₄₋ₓNx:Eu²⁺ (0<x<2), which are oxynitride phosphors; nitridosilicate phosphor (Ba,Sr,Ca)₂Si₅N₈:Ce³⁺ which is a nitride phosphor; a thiogallate phosphor CaGa₂S₄:Eu²⁺; a garnet phosphor Ca₃Sc₂Si₃O₁₂:Ce³⁺, BaY₂SiAl₄O₁₂:Ce³⁺, etc. may be used. As an orange phosphor, α-sailon phosphor Ca-α-SiAlON:Eu²⁺, etc. may be used. As a red phosphor, (Y,Gd)₃Al₅O₁₂:Ce³⁺, a sulfide phosphor La₂O₂S:Eu³⁺,Sm³⁺, a silicate phosphor Ba₃MgSi₂O₈:Eu²⁺,Mn²⁺, a nitride or oxynitride phosphor (Ca,Sr)SiN₂:Eu²⁺, (Ca,Sr)AlSiN₃:Eu²⁺ or Sr₂Si₅₋ₓAlₓOₓN₈₋ₓ:Eu²⁺ (0≦x≦1), etc. may be used. When only using yellow-green phosphor particles, the white color rendering properties are low (Ra≧80), but luminous efficiency is high. On the other hand, when mixing yellow-green phosphor particles and red phosphor particles, the luminous efficiency of white light becomes lower, but the color rendering properties are higher (Ra≦80), thus achieving light that is better suited as an illumination light source.

When yellow-green phosphor particles and red phosphor particles are used in the phosphor film 36 of a blue LED chip, a portion of the blue light emitted from the LED chip is absorbed in the phosphor film 36 and converted into yellow-green light and red light. Blue, yellow-green, and red light combine to form white light, which is emitted mainly from the upper surface (light-emitting surface) of the phosphor film 36. The “light-emitting direction” of the LED module 10 is defined here as the direction perpendicular to the surface of the printed circuit board 34, the surface being where the LED chips (not shown in the figures) are mounted.

The LED module 10 is mounted on the inner bottom of the main portion 30 by bonding the rear surface of the printed circuit board 34 with a highly heat-conductive paste. Note that a highly heat-conductive paste is not the only option to attach the printed circuit board 34 to the main portion 30 and a highly heat-conductive sheet may be used instead. Alternatively, a different fixing means may be used, such as fixing the edge of the printed circuit board 34 with a screw, pressing the printed circuit board 34 through the socket, etc. As long as efficient transmission of heat from the LED chips to the main portion 30 is ensured thereby to lower the temperature of the LED chips, the fixing means is not limited.

Examples of the printed circuit board include a resin-based printed circuit board, such as a paper-phenolic board or a glass epoxy board, a ceramic board such as alumina, a metal-based printed circuit board formed by laminating a resin-based insulating layer to a metal such as aluminum.

This example may be modified to use a large number of LED chips to constitute the LED module 10 or a plurality of LED modules 10 and correspondingly increase the dimensions of the casing composed of the first body 6 and the second body 8 to improve heat dissipation. Such a modification achieves even higher luminance and thus usable a replacement for a high-intensity discharge (HID) lamp, for example.

The second body 8 is formed from a highly heat-conductive material such as aluminum and also serves as a heatsink for dissipating heat produced by the LED module 10. The second body 8 has a through-hole 38 for the first lead wire 26 and the second lead wire 28 to pass through. The first lead wire 26 and the second lead wire 28 drawn to pass through the through-hole 38 are connected, as shown in FIG. 2C, to the first power supply land 34A and the second power supply land 34B, respectively (the lead wires 26 and 28 are not shown in FIGS. 3A and 3B).

The globe 40 for covering the LED module 10 therein is attached to the main portion 30 of the second body 8. The globe 40 is formed from a transparent material such as glass or synthetic resin. Note that mating portion 32 of the second body 8 will be described later in detail. To improve the light diffusibility of the globe, the inner surface of the globe may be coated with a film of silica powder.

Returning to FIG. 1, the base 4 is attached to a socket (not shown in the figures) of, for example, a downlight fixture. It goes without saying that the base 4 is attached by being rotated to be screwed into the socket. The central axis (imaginary axis) of rotation at this time is defined as X.

The first body 6 is mounted to the base 4 to be rotatable about the central axis X. The second body 8 is mounted to the first body to be swingable on an imaginary axis that intersects the central axis X (at a right angle in this example) (hereinafter, the imaginary axis is referred to as “swing axis Y1”). An example of a structure for the first body 6 to be rotatable and for the second body 8 to be swingable is described below.

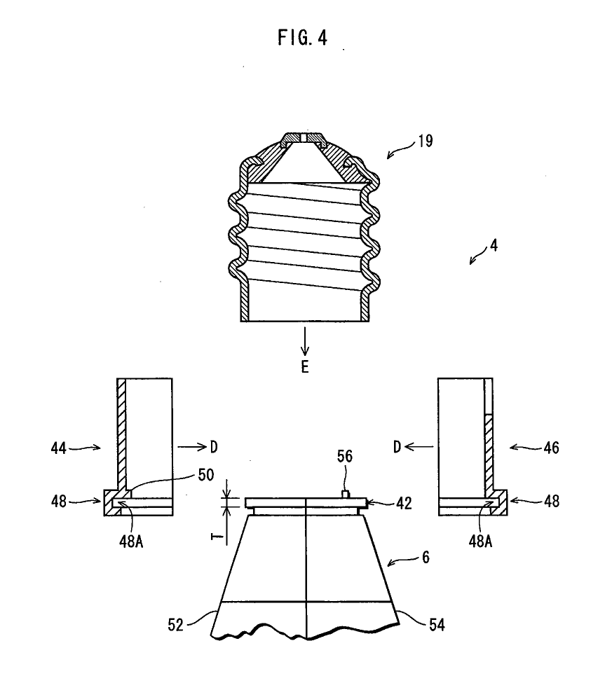

FIG. 4 is an exploded view of the base 4 and part of the first body 6, in which each component is shown in cross section. The following describes each component in detail, while also describing assembly of the components with reference to FIG. 4.

The first body 6 has a base connecting portion 42 shaped as an annular flange at one end thereof.

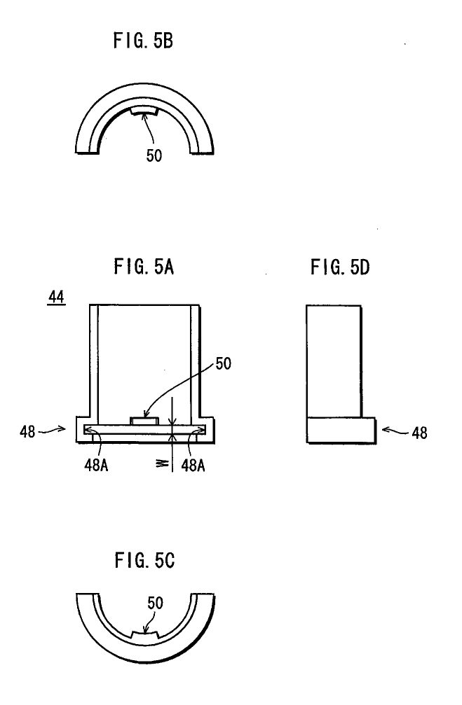

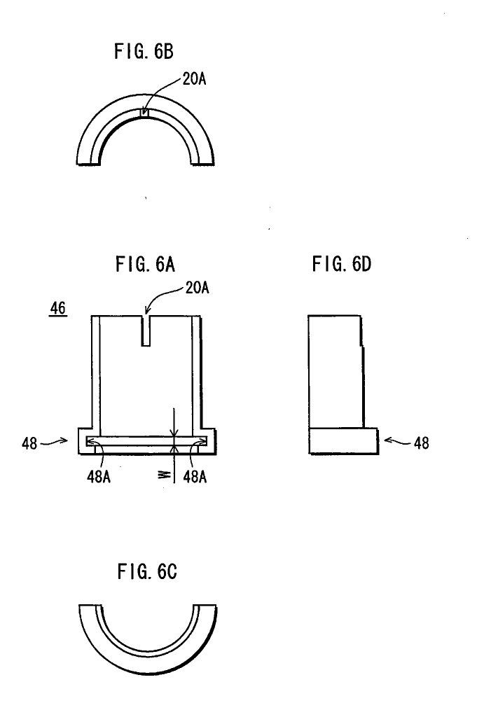

FIGS. 5 and 6 each show a first half-cylinder member 44 and a second half-cylinder member 46 both of which are the components of the second insulating member 20 of the base 4 (FIG. 1).

FIG. 5A is a front view, FIG. 5B is a plan view, FIG. 5C is a bottom view, and FIG. 5D is a right side view, all being views of the first half-cylinder member 44.

Note that the left side view is represented in the same way as the right side view and thus omitted.

As shown in FIGS. 5A-5D, the first half-cylinder member 44 has an overall shape of a half-cylinder, as its name indicates. At one lengthwise end, the first half-cylinder member 44 has a portion that diametrically protrudes to define a squared U-shape. This protrusion forms half of a first body connecting portion 48 described below. In addition, the first half-cylinder member 44 has a projection 50 projecting from an inner surface thereof.

FIG. 6A is a front view, FIG. 6B is a plan view, FIG. 6C is a bottom view, and FIG. 6D is a right side view, all being views of the second half-cylinder member 46. Note that the left side view is represented in the same way as the right side view and thus omitted.

As shown in FIGS. 6A-6D, the second half-cylinder member 46 has an overall shape of a half-cylinder, as its name indicates. At one lengthwise end, the second half-cylinder member 46 has a portion that diametrically protrudes to define a squared U-shape. This protrusion forms the other half of the first body connection unit 48 mentioned above. The slit 20A (FIG. 1) is formed at the other end of the second half-cylinder member 46.

As described below, the base connecting portion 42 (FIG. 4A) of the first body 6, shaped as an annular flange, is fitted into a groove 48A present inside the U-shaped protruding portion of the first body connection unit 48 formed by the first half-cylinder member 44 and second half-cylinder member 46. The width W (FIGS. 5A and 6A) of the groove 48A is set to be slightly shorter than the thickness T of the base connecting portion 42 shown in FIG. 4.

Note that the first half-cylinder member 44 and the second half-cylinder member 46 are formed from synthetic resin, which is an insulating material.

Returning to FIG. 4, assembly of the integral base body 19, first half-cylinder member 44, second half-cylinder member 46, and first body 6 is described. In the following description of the assembly, which will be given with reference to FIG. 4, the first feeder line 22 and the second feeder line 24 are not mentioned.

First, the first half-cylinder member 44 and second half-cylinder member 46 are brought together in the direction indicated by the arrows D to form the second insulating member 20 (FIG. 1). At this point, the first body 6 and the first body connection unit 48 are assembled together by fitting the base connecting portion 42, which is shaped as annular flange, into the groove 48A, which has a squared U-shape cross-section. Since the width W (FIGS. 5A and 6A) of the groove 48A is set to be slightly shorter than the thickness T of the base connecting portion 42, the first body connecting portion 48 of the first half-cylinder member 44 and the second half-cylinder member 46 elastically deforms to slightly widen the width W of the groove 48A.

Once the second insulating member 20 is formed, the integral base body 19 is placed over the second insulating member 20 in the direction indicated by the arrow E. The integral base body 19 and the second insulating member 20 are connected with an adhesive or the like, not shown in the figures. Alternatively, the second insulating member 20 may be provided with a screw threaded lateral surface, so that the integral base body 19 is secured by screwing in, followed by riveting the lateral surface of the integral base body 19 in the direction toward the central axis X shown in FIG. 1A.

The first body 6 is thus attached to the base 4 so as to be freely rotatable relative to the base 4 in the directions of the arrows F about the central axis X shown in FIG. 1A. Yet, the first body 6 does not arbitrarily rotate around the base 4 because the base connecting portion 42 is sandwiched due to the restoring force of the first body connecting portion 48 elastically deformed.

Next, details on the first body 6, and on the assembly (connection) of the first body 6 and the second body 8 are provided.

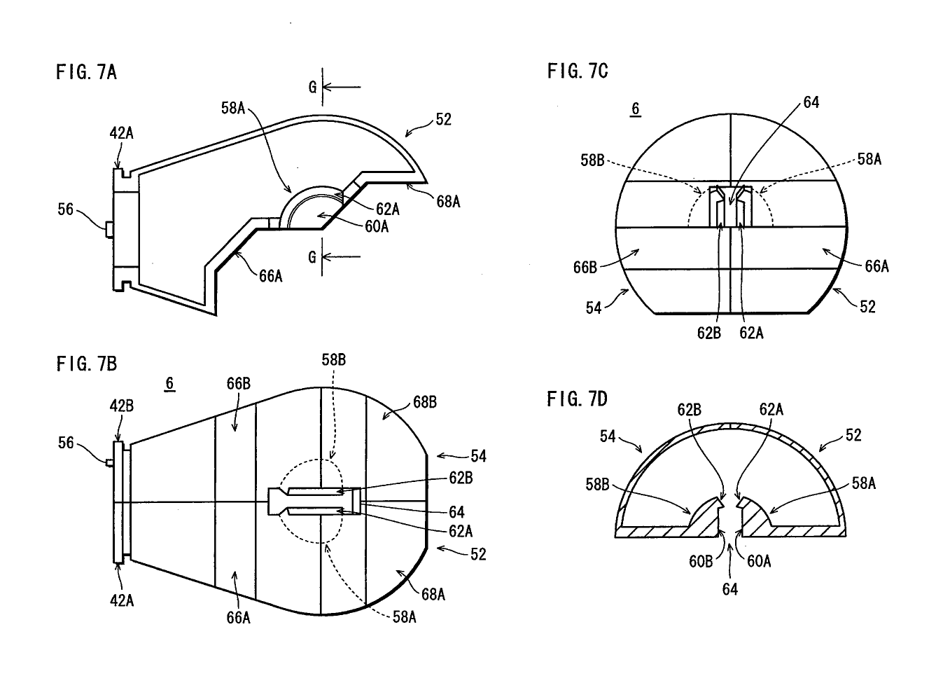

FIG. 7 shows the first body 6. The first body 6 is composed of a first half-shell member 52 and a second half-shell member 54 assembled together so that the open end of the respective half-shell members 52 and 54 abut against each other. The first half-shell member 52 and second half-shell member 54 are formed from a highly heat-conductive material such as aluminum or other suitable material. The first half-shell member 52 and second half-shell member 54 are symmetrical about the imaginary plane containing the open ends, except for whether a projection 56 is provided or not. FIG. 7A is a front view of the first half-shell member 52 seen from the open end. FIG. 7B is a bottom view of the first body 6 (i.e., the first half-shell member 52 and second half-shell member 54 assembled together). FIG. 7C is a right side view of the first body 6. FIG. 7D is an end view of the first body 6 taken along the line G-G shown in FIG. 7A.

As described above, the first half-shell member 52 and the second half-shell member 54 are basically of symmetrical configuration. Therefore, the same reference signs are used to denote corresponding portions of the respective half-shell members, followed by “A” for the portions of the first half-shell member 52 and by “B” for the portions of the second half-shell member 54.

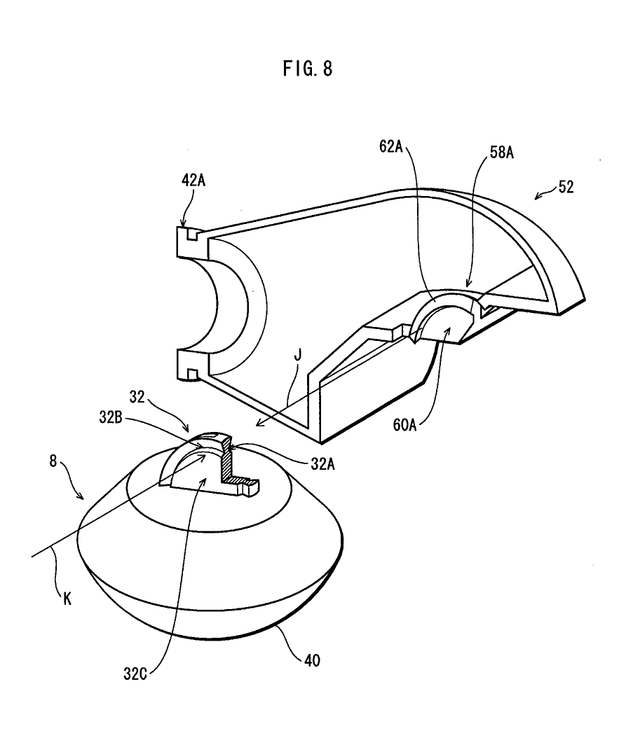

FIG. 8 is an oblique view of the first half-shell member 52 and the second body 8 with the globe 40 attached thereto. In FIG. 8, the mating portion 32 of the second body 8 is illustrated with a portion cut away to clearly show the cross sectional shape.

With reference to FIGS. 7 and 8, the following describes the first and second half-shell members 52 and 54.

The half-shell members 52 and 54 have semi-annular flanges 42A and 42B each at one end thereof. The semi-annular flanges 42A and 42B together form the base connecting portion 42 described above.

The semi-annular flange 42A of the first half-shell member 52 has the projection 56 on the end surface thereof.

Each of the half-shell members 52 and 54 has the shape of about one-quarter sphere and is provided with a supporting portion 58A or 58B for slidably supporting the mating portion 32 of the second body 8 (FIGS. 2 and 3).

The supporting portions 58A and 58B respectively have slide surfaces 60A and 60B each defining a fun shape with an obtuse sector angle. The supporting portions 58A and 58B are arranged so that the respective slide surfaces 60A and 60B are opposed to each other.

Provided along the peripheral edges of the slide surfaces 60A and 60B are guide rails 62A and 62B each of which is generally V-shaped in cross section. Naturally, the guide rails 62A and 62B are also curved along an arc.

The supporting portions 58A and 58B are opposed to each other across a gap 64 into which the mating portion 32 of the second body 8 is fitted.

With reference to FIGS. 3 and 8, the following describes the mating portion 32 of the second body 8.

The mating portion 32 which is in the form of a semi-circular plate has a pair of grooves 32A and 32B for receiving the guide rails 62A and 62B. Each of the grooves 32A and 32B is formed in a different lateral surface to extend circumferentially along the peripheral edge of the mating portion 32. Each of the grooves 32A and 32B has a cross sectional shape conforming to a corresponding one of the guide rails 62A and 62B. That is, the grooves 32A and 32B are also curved along an arc. Note that the mating portion 32 excluding where the groves 32A and 32B are present has a uniform thickness and the uniform-thickness portion of the semi-circular plate is referred to as a slide portion 32C. The thickness of the slide portion 32C is set to be slightly wider than the gap 64 (FIG. 7D).

As shown in FIG. 8, the first half-shell member 52 and the second half-shell member 54 (not illustrated in FIG. 8) are assembled together by pressing the guide rail 62A in the direction indicated by the arrow J and the guide rail 62B (not illustrated in FIG. 8) in the direction indicated by the arrow K to be fitted within the respective grooves 32A and 32B.

Consequently, the guide rails 62A and 62B are fitted into the grooves 32A and 32B as shown in FIG. 1B, so that the mating portion 32 is supported by the supporting portions 58A and 58B. Therefore, the guide rails 62A and 62B are guided by the grooves 32A and 32B of the mating portion 32 to allow the second body 8 to be swing relative to the first body 6 about the swing axis Y1 in the direction indicated by the arrow H.

In one example, the first half-shell member 52 and the second half-shell member 54 are bonded together with heat resistant adhesive or the like applied between the abutting surfaces. In another example, one of the first half-shell member 52 and the second half-shell member 54 may be provided with a cylindrical projection rising from the abutting surface, and the other with a hole provided at a corresponding location on the abutting surface. The respective half-shell members 52 and 54 are then joined together by press-fitting the projection into the hole.

The spatial range within which the second body 8 swingable is between (i) the position at which an outer surface 30A of the main portion 30 of the second body 8 contacts a first regulating surface 66 of the first body 6 and (ii) the position at which the outer surface 30A contacts a second regulating surface 68 of the first body 6. In the example shown in FIG. 1, the second body 8 is swingable within an angular range of 45°. That is, the LED module 10 can be positioned anywhere within such a range that the angle at which the light-emitting direction intersects the central axis X is from 90° to 45°.

The bulb-type LED lamp 2 having the above structure can be attached to a lighting fixture in the following manner, and is therefore suitable for use with a lighting fixture having a socket oriented to require the base 4 to be inserted from a direction falling between a horizontal direction and a vertically downward direction which forms an angle of 45° with the horizontal direction.

To attach the bulb-type LED lamp 2 to a lighting fixture, the bulb-type LED lamp 2 is held by the first body 6 or by both the first body 6 and the second body 8 and rotated to insert the base 4 into a socket (not shown in the figures) of the lighting fixture. Note that the socket increasingly resists screwing of the base 4 partway through insertion. Yet, the projection 58 provided on the first body 6 acts as a whirl-stop, coming into contact with the projection 50 provided on the second insulating member 20 of the base 4 and preventing the first body 6 from rotating more than one turn (360 degrees) with respect to the base 4.

After completion of the attachment to the lighting fixture, the first body 6 is rotated about the central axis X relative to the base 4 to swing the second body 8 to such a position that the second body 8 is slidable in the vertical direction. Then, the second body 8 is swung on the swing axis Y1 to such a position that the light-emitting direction coincides with a downwardly vertical direction.

As described above, the thickness of the slide portion 32C is set to be slightly wider than the gap 64, so that the slide portion 32C makes intimate contact with the slide surfaces 60A and 60B to provide frictional resistance therebetween. This frictional resistance serves to prevent undesirable sliding of the second body 8 and thus hold the second body 8 in place.

Furthermore, since the slide portion 32C makes surface contact with the slide surfaces 60A and 60B, heat is transmitted from the second body 8 to the first body 6 through the contacted surfaces. In this way, the first body 6 serves as a heatsink, which improves dissipation of heat produced by the LED module 10 (LED chips).

In addition, the provision of the first body for housing the lighting circuit unit 12 allows the lighting circuit unit to be dully housed without being required to be confined in a small space such as the cavity inside the base. This structure allows a base for a small incandescent light bulb to be used to constitute a bulb-type LED lamp which is dully usable as a replacement for a small incandescent light bulb. In the example shown in FIG. 1, the second body 8 is swingable from such a position that the light-emitting direction of the LED module 10 intersects the central axis X at 90° to such a position that the light-emitting direction of the LED module 10 intersects the central axis X at 45°. In addition, the first body 6 has a space for housing the lighting circuit unit 12 at a location about the swing axis Y1 excluding a spatial range within which the second body 8 is swingable. This enables enough space to be secured for housing a lighting circuit unit, without compromising the overall shape resembling an incandescent light bulb.

Up to this point, the present invention has been described by way of Embodiment 1. It should be naturally appreciated, however, that the present invention is not limited to the specific embodiment described above and various modifications including the following may be made.

### (Modification 1)

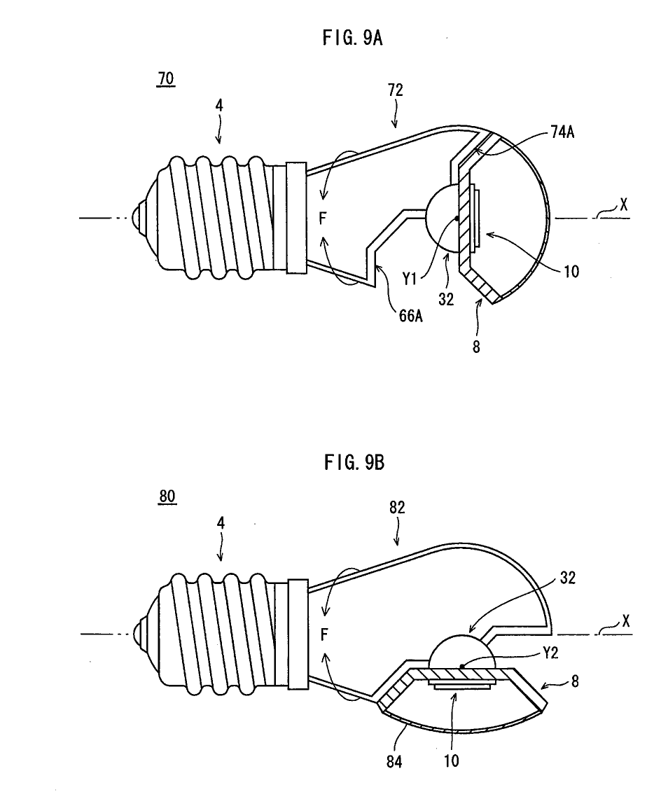

FIG. 9A is a view schematically showing a structure of a bulb-type LED lamp 70 according to Modification 1. Note that FIG. 9A is drawn based on FIG. 1A. In FIG. 9A, however, the base 4 is not cut away and the mating portion 32 of the second body 8 is simplified. The bulb-type LED lamp 70 according to Modification 1 is basically identical in structure to the bulb-type LED lamp 2 according to Embodiment 1, except for the configuration of the first body. Therefore, the same reference signs are used to denote the components common to Embodiment 1 and no detailed description thereof is given here. The following description focuses on the above differences.

In the bulb-type LED lamp 2 according to Embodiment 1, the spatial range within which the second body 8 is swingable is from the position at which the light-emitting direction intersects the central axis X at 90° to the position at which the light-emitting direction intersects the central axis X at 45°. By contrast, in the bulb-type LED lamp 70 according to Modification 1, the range within which the second body 8 is swingable is extended. More specifically, the second body 8 is swingable from the position at which the light-emitting direction intersects the central axis X at right angle to the position at which the light-emitting direction becomes parallel to the central axis X (that is, the swingable angular range is 90°.

Therefore, in the bulb-type LED lamp 70, a second regulating surface 74 of the first body 72 is located further back toward the base 4.

The bulb-type LED lamp 70 having the above structure is suitable for use with a lighting fixture having a socket oriented to require the base 4 to be inserted from a direction between the horizontal direction and the vertically downward direction.

In the description given above, the spatial range within which the second body 8 swings is either of the following two ranges: (i) from the position at which the light-emitting direction intersects the central axis X at 90° to the position at which the light-emitting direction intersects the central axis X at 45° (angular range of 45°); and (ii) from the position at which the light-emitting direction intersects the central axis X at 90° to the position at which the light-emitting direction becomes parallel to the central axis X (angular range of 90°). However, the angular range can be set to any desired range from 45° to 90°. In the examples shown above, the angular range is adjusted by changing the position of the second regulating surface 68A or 74A.

However, the angular range exceeding 90° is not desirable as the spatial range in which the second body 8 is swingable becomes too wide, which ends up occupying more of the internal space of the first body that would otherwise be usable for housing a lighting circuit unit. In addition, there is no great necessity for the angular range exceeding 90° because the first body 6 or 72 is rotatable nearly 360° relative to the base 4. In view of the above, the desirable range in which the second body 8 is swingable is from the position at which the light-emitting direction intersects the central axis X at a right angle to the position at which the light-emitting direction becomes parallel to the central axis X at maximum.

### (Modification 2)

FIG. 9B is a view schematically showing a structure of a bulb-type LED lamp 80 according to Modification 2. Note that FIG. 9B is drawn based on FIG. 1A. In FIG. 9B, however, the base 4 is not cut away and the mating portion 32 of the second body 8 is simplified. The bulb-type LED lamp 80 according to Modification 2 is basically identical in structure to the bulb-type LED lamp 2 according to Embodiment 1, except for the configuration of the second body and the globe. Therefore, the same reference signs are used to denote the components common to Embodiment 1 and no detailed description is given here. The following description focuses on the above differences.

In the bulb-type LED lamp 80 according to Modification 2, the angular range within which the second body 8 is swingable is 45°, which is the same as that of the bulb-type LED lamp 2 according to the Embodiment 1. However, the swing axis is offset from the central axis X.

More specifically, according to Embodiment 1, the swing axis Y1 intersecting the central axis X is on the same imaginably plane as the central axis X. According to Modification 2, however, the swing axis Y2 intersecting the central axis X (at an angle of 90°) is on a different imaginably plane.

In other words, the second body 8 is configured so that the swing axis Y2 is offset toward the direction away from the central axis X. This structure serves to increase the internal space (capacity) of the first body 82, which makes it even easier to house the lighting circuit unit (not illustrated) and other component(s).

Since the swing axis is offset as described above, a globe 84 provided for the second body 8 is of lower profile as compared to that used in Embodiment 1 in order to keep the overall shape of the LED lamp to more closely resemble an incandescent light bulb.

### Embodiment 2

As shown in FIG. 1A, the bulb-type LED lamp 2 according to Embodiment 1 is provided with only one pair of lead wires, namely the lead wires 26 and 28 to establish electrical connection between the lighting circuit unit 12 and the LED module 10. According to Embodiment 2, by contrast, electrical connection between the lighting circuit unit 12 and the LED module 10 is established partly using a wiping contact.

Except that the wiping contact is employed, a bulb-type LED lamp 90 according to Embodiment 2 is basically identical in structure to the LED lamp 2 according to Embodiment 1. Therefore, no description of such common components is given, and the structure of wiping contact is described below.

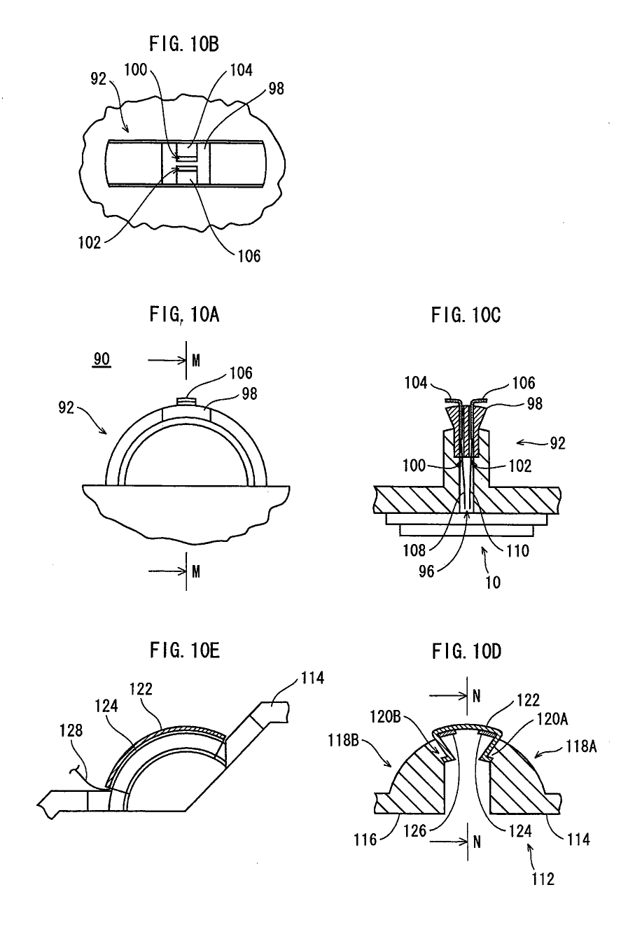

FIG. 10A is a front view and FIG. 10B is a plan view of a mating portion 94 of a second body 92 of the bulb-type LED lamp 90. FIG. 10C is a cross sectional view taken along the line M-M shown in FIG. 10A.

The mating portion 94 has a through-hole 96 (corresponding to the through-hole 38 of Embodiment 1 shown in FIG. 3) in which an insulating member 98 is buried. The insulating member 98 is formed from synthetic resin.

The insulating member 98 has two separate terminal-fixing holes 100 and 102 both of which are in communication with the through-hole 96.

Movable contacts 104 and 106 each formed of a metallic strip bent into an L-shape is partly buried in a corresponding one of the terminal-fixing holes 100 and 102.

Each of the movable contacts 104 and 106 is connected at a buried end to an end of a corresponding one of lead wires 108 and 110. The lead wires 108 and 110 are connected at the other end to the LED module 10 in a manner similar to Embodiment 1.

FIG. 10D is a cross sectional view of the first body 112 to show where a supporting portion 118A of a first half-shell member 114 and a supporting portion 118B of a second half-shell member 116 confront each other. Note that FIG. 10D is drawn based on FIG. 7D. FIG. 10E is a sectional view taken along the line N-N shown in FIG. 10D.

Between the opposing guide rails 120A and 120B of the supporting portions 118A and 118B, a channel member 122 is attached. The channel member 122 generally has a squared U-shape in cross section and curved to define an arc shape in a lengthwise direction. The channel member 122 is made from an insulating material, such as synthetic resin.

Two fixed contacts 124 and 126 each made of a metallic strip are attached on the inner bottom of the channel member 122 to be longitudinally in parallel to each other. Each of the fixed contacts 124 and 126 is connected at one end to an end of a lead wire (FIG. 10E shows only one of the lead wires, namely the lead wire 128 that is connected to the fixed contact 124). The other end of each lead wire is connected to the lighting circuit unit (not illustrated).

As described above, the mating portion 94 having the fixed contacts 100 and 102 are fitted between the respective supporting portions 118A and 118B of the first body 112 in a manner similar to Embodiment 1.

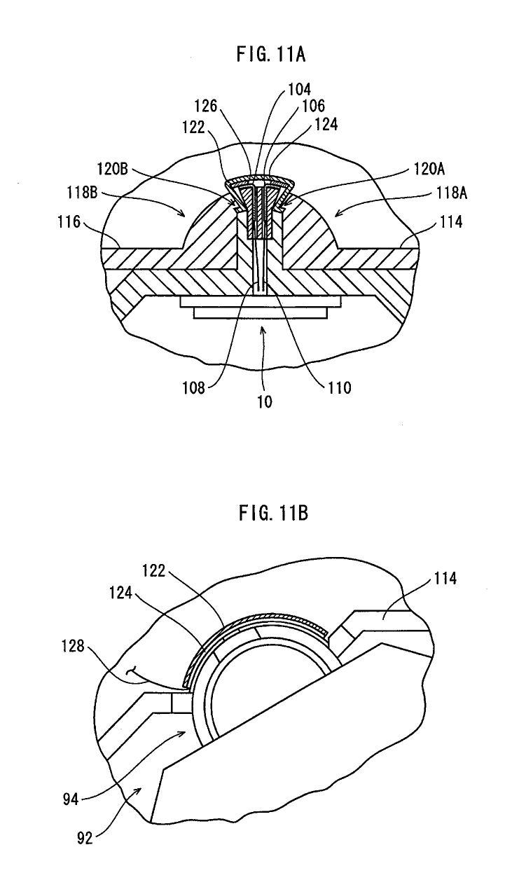

FIG. 11A shows a cross section taken along the line shown in FIG. 10D, in the fitted (assembled) state. Similarly, FIG. 11B shows a cross section taken along the line shown in FIG. 10E. In FIG. 11B, the second body 92 is not cut away.

In the fitted state, the movable contacts 104 and 106 come into contact with the fixed contacts 126 and 124, respectively. In this state, the portions of the movable contacts 104 and 106 exposed from the insulating member 98 are resiliently flexed, exerting the restoring force to hold the exposed portions in engagement against the fixed contacts 126 and 124. Consequently, electrical connection is reliably established.

Furthermore, the movable contacts 104 and 106 are ensured to be in contact with the fixed contacts 126 and 124, respectively, throughout the spatial range in which the second body 92 is swingable.

According to Embodiment 1, portions of the lead wires 26 and 28 (see FIG. 1A) located between the lighting circuit unit 12 and the second body 8 change as the second body 8 swings, which may involve the risk of breaks at such portions. According to Embodiment 2, however, the risk of breaks is avoided as the wiping contact is employed.

Up to this point, the present invention has been described by way of the above embodiments. It should be naturally appreciated, however, that the present invention is not limited to the specific embodiments described above and various modifications including the following may be made.

(1) In the embodiments described above, the first body 6 is provided with the guide rails 62, whereas the second body 8 is provided with the grooves 32A and 32B. Alternatively, however, the reverse is also applicable. That is, the second body is provided with guide rails, whereas the first body is provided with grooves for fit engagement with the guide rails.
(2) According to the embodiments described above, the second body 8 is provided with the globe 40. However, the provision of the globe is not necessarily required.
(3) In the embodiments described above, LEDs are used as an example of light-emitting elements, but the light-emitting elements in the light-emitting module are not limited to LEDs, and may for example be electroluminescent devices, field emission devices, etc.

### INDUSTRIAL APPLICABILITY

The bulb-type lamp according to the present invention is highly usable as a bulb-type LED lamp that replaces mini krypton bulbs, for example.

### Reference Signs List

2 bulb-type LED lamp
4 base
6 first body
8 second body
10 LED module
12 lighting circuit unit

1. A bulb-type lamp comprising:
a base to be inserted into a socket by being rotated about a central axis of the base;
a first body attached to the base to be freely rotatable about the central axis;
a second body attached to the first body to be swingable about a swing axis that intersects the central axis;
a light-emitting module mounted on the second body; and
a lighting circuit unit configured to light the light-emitting module, wherein
the lighting circuit unit is housed in the first body,
the second body is swingable at most between a position at which a light-emitting direction of the light-emitting module intersects the central axis at a right angle and a position at which the light-emitting direction becomes parallel to the central axis, and
the first body has a space housing the lighting circuit unit at a location about the swing axis excluding a spatial range within which the second body is swingable.

2. (canceled)

3. The bulb-type lamp according to claim 1, wherein
the lighting circuit unit includes a printed circuit board attached to the first body and a plurality of electronic components mounted on the printed circuit board, the printed circuit board being housed in the first body, and
an interior space of the base and an interior space of the first body are in communication, and at least part of one of the electronic components protrudes into the interior space of the base.

4. The bulb-type lamp according to claim 1, wherein
one of the first body and the second body has a groove curved to define an arc having a center on the swing axis, and another of the first body and the second body has a guide rail fitted into the groove, the second body being swingable relative to the first body by the guide rail sliding within the groove.

5. The bulb-type lamp according to claim 3, wherein
one of the first body and the second body has a groove curved to define an arc having a center on the swing axis, and another of the first body and the second body has a guide rail fitted into the groove, the second body being swingable relative to the first body by the guide rail sliding within the groove.
